(19) United States
(12) Patent Application Publication
(10) Pub. No.: US 2015/0076328 A1
(43) Pub. Date: Mar. 19, 2015

(54) WAFER-SHAPED TOOL CONFIGURED TO MONITOR PLASMA CHARACTERISTICS AND PLASMA MONITORING SYSTEM USING THE SAME

(71) Applicants: Jaechul JUNG, Seoul (KR); Dong Ok SHIN, Suwon-si (KR); Sangheon LEE, Seongnam-si (KR)

(72) Inventors: Jaechul JUNG, Seoul (KR); Dong Ok SHIN, Suwon-si (KR); Sangheon LEE, Seongnam-si (KR)

(21) Appl. No.: 14/324,652

(22) Filed: Jul. 7, 2014

(30) Foreign Application Priority Data
Sep. 16, 2013 (KR) 10-2013-0111395

(51) Int. Cl. H05H 1/00

(52) U.S. Cl. CPC H05H 1/0025
USPC 250/208.2

(57) ABSTRACT

Provided are tools and systems to monitor plasma characteristics. The tool may include a housing, and a sensor array, a signal processor, and a data-transferring device provided in the housing. The sensor array may include a plurality of measurement sensors two-dimensionally arranged in the housing, each of the measurement sensors including a shielding layer configured to prevent an electrical interaction with charged particles in plasma, the signal processor may be configured to process electrical signals produced by the measurement sensors, and thereby generate measurement data, and the data-transferring device may be configured to transmit the measurement data to the outside.

### CROSS-REFERENCE TO RELATED APPLICATION

This application claims priority under 35 U.S.C. §119 to Korean Patent Application No. 10-2013-0111395, filed on Sep. 16, 2013, in the Korean Intellectual Property Office, the entire contents of which are hereby incorporated by reference in their entirety.

### BACKGROUND

1. Field

Exemplary embodiments relate to tools and systems of monitoring plasma characteristics.

2. Description of the Related Art

A plasma process is used for fabricating devices (e.g., semiconductor devices) with fine patterns. For example, plasma is used for film deposition, etching, and ashing processes. To improve properties and yield of products, it may be necessary to exactly monitor and control spatial distribution of plasma used in the process.

Several monitoring methods, such as an optical emission spectroscopy (OES) and a voltage and current probe, have been suggested to measure and analyze plasma characteristics. However, according to these methods, a measurement tool outside a chamber is used to measure characteristics of plasma produced in the chamber, and thus, the measurement tool cannot provide information on plasma characteristics in the form of two-dimensional distribution data.

### SUMMARY

Exemplary embodiments provide a plasma monitoring tool that can be loaded in a chamber.

Exemplary embodiments also provide a plasma monitoring tool capable of measuring two-dimensional distribution characteristics of plasma.

Still other exemplary embodiments provide a plasma system capable of measuring and controlling two-dimensional distribution characteristics of plasma.

According to an exemplary embodiment, there is provided a sensor structure including a substrate, a photoelectric conversion device provided on the substrate, a light-guide structure provided on the photoelectric conversion device, and an upper shielding layer provided on the photoelectric conversion device. The upper shielding layer includes a conductive material configured to prevent the photoelectric conversion device from electrically interacting with charged particles in plasma.

According to an exemplary embodiment, the upper shielding layer includes a transparent conductive layer formed to cover at least one of a top surface and a bottom surface of the light-guide structure.

According to an exemplary embodiment, the upper shielding layer includes a metal layer provided on the light-guide structure or at a side of the light-guide structure opposite to a side at which the plasma is located.

According to an exemplary embodiment, the substrate includes a flexible printed circuit board including a wiring structure electrically connecting the photoelectric conversion device to an external electronic device.

According to an exemplary embodiment, the substrate is a semiconductor wafer or a plate-shaped structure including a semiconductor layer, and the photoelectric conversion device includes electric components integrated on the substrate.

According to an exemplary embodiment, the photoelectric conversion device includes at least one of a photodiode or an image sensor including a photodiode and at least one transistor.

According to an exemplary embodiment, the sensor structure may further include an optical filter provided on the photoelectric conversion device, the optical filter being configured to enable only light with a specific wavelength to be incident into the photoelectric conversion device.

According to an exemplary embodiment, the sensor structure may further include a lower shielding layer provided at a side of the photoelectric conversion device of the light-guide structure opposite to a side at which the plasma is located. The lower shielding layer includes a metal layer.

According to an exemplary embodiment, the light-guide structure includes an optically-transparent lens or a cover with at least one through hole.

According to an exemplary embodiment, the sensor structure may further include a cover layer provided on the photoelectric conversion device. The cover layer has an opening, in which the light-guide structure is provided, and the cover layer includes silicon, silicon oxide, or ceramics.

According to an exemplary embodiment, there is provided a plasma monitoring tool including a housing, and a sensor array, a signal processor, and a data-transferring device, each of the sensor array, the signal processor, and the data-transferring device being provided in the housing. The sensor array includes a plurality of measurement sensors two-dimensionally arranged in the housing, each of the measurement sensors including a shielding layer configured to prevent an electrical interaction with charged particles in plasma, the signal processor may be configured to process electrical signals produced by the measurement sensors, and thereby generate measurement data, and the data-transferring device is configured to transmit the measurement data to the outside.

According to an exemplary embodiment, each of the measurement sensors further includes a light-guide structure including an optically-transparent lens or a cover with at least one through hole.

According to an exemplary embodiment, the shielding layer includes a transparent conductive layer or a metal layer provided on the light-guide structure or at a side of the light-guide structure opposite to a side at which the plasma is located.

According to an exemplary embodiment, the plasma monitoring tool may further include a flexible printed circuit board provided in the housing and provided with a wiring structure. The sensor array, the signal processor, and the data-transferring device are mounted on the flexible printed circuit board and are electrically connected to each other via the wiring structure.

According to an exemplary embodiment, each of the measurement sensors includes a photoelectric conversion device mounted on the flexible printed circuit board.

According to an exemplary embodiment, the housing includes a plate-shaped lower housing, and an upper housing including at least one opening formed at a position corresponding to a position of one of the measurement sensors. The upper housing includes silicon, silicon oxide, or ceramics.

According to an exemplary embodiment, the plate-shaped lower housing includes a semiconductor wafer or a plate-shaped structure including a semiconductor layer, and each of the measurement sensors includes a photoelectric conversion device integrated on a top surface of the plate-shaped lower housing.

According to an exemplary embodiment, the plasma monitoring tool may further include a data storage provided in the housing to store the measurement data, and a power-supplying device provided in the housing to supply electric power to electronic components in the housing.

According to an exemplary embodiment, the data-transferring device includes a data transfer module configured to wirelessly transmit the measurement data, in the form of an electromagnetic wave, to the outside.

According to an exemplary embodiment, the signal processor includes a current-voltage converter configured to convert current signals generated in the measurement sensors into voltage signals, a signal-amplifier configured to amplify electrical signals transmitted from the measurement sensors or the voltage signals transmitted from the current-voltage converter, a signal filter configured to remove noises from the amplified signals and thereby generate filtered signals, and an analog-digital converter configured to convert the filtered signals to a digital signal.

According to an exemplary embodiment, the plasma monitoring tool may further include a calculator provided in the housing to obtain plasma property data from the electrical signals or the digital signal.

According to an exemplary embodiment, the plasma monitoring tool may further include a switch provided in the housing, the switch being configured to selectively provide access to one of the measurement sensors.

According to an exemplary embodiment, the measurement sensors include at least one first measurement sensor and at least one second measurement sensor, and the first and second measurement sensors are configured to respectively measure first light and second light having wavelengths which are different from each other.

According to an exemplary embodiment, the plasma monitoring tool may further include a light emitter disposed in the housing. The light emitter is configured to emit light having a wavelength which is in a range that can be detected by the measurement sensors.

According to an exemplary embodiment, there is provided a plasma chamber system including the above-described plasma monitoring tool, a chamber configured to generate the plasma, and a communication device, a calculator, and a storage. The communication device is configured to read out the measurement data from the plasma monitoring tool, the calculator is configured to calculate plasma property data from the measurement data, and the storage is configured to store algorithms to be used by the communication device for the reading out of the measurement data and to be used by the calculator to calculate the plasma property data, and is further configured to store the measurement data.

According to an exemplary embodiment, the plasma chamber system may further include a container configured to contain the plasma monitoring tool. The container includes a charging module configured to charge a battery provided in the plasma monitoring tool, in a wireless manner.

According to an exemplary embodiment, the plasma chamber system may further include a load-lock chamber configured to preserve the chamber and the container in a vacuum state.

According to an exemplary embodiment, the communication device is provided in the container.

According to an exemplary embodiment, the communication device is provided in the chamber and is configured to read out the measurement data in real time.

According to an exemplary embodiment, the plasma chamber system may further include a gas-supplier configured to supply a process gas into the chamber, and a high-frequency generator configured to generate and apply a high-frequency wave to the chamber. At least one of the gas-supplier or the high frequency generator is controlled based on the plasma property data.

### BRIEF DESCRIPTION OF THE DRAWINGS

Exemplary embodiments will be more clearly understood from the following brief description taken in conjunction with the accompanying drawings. The accompanying drawings represent non-limiting, exemplary embodiments as described herein.

FIG. 1 is a block diagram schematically illustrating a plasma chamber system according to an exemplary embodiment;

FIG. 2 is a block diagram schematically illustrating a plasma monitoring tool according to an exemplary embodiment;

FIG. 3 is a plan view exemplarily illustrating a plasma monitoring tool according to an exemplary embodiment;

FIG. 4 is a circuit diagram exemplarily illustrating a switching unit according to an exemplary embodiment;

FIG. 5 is a block diagram schematically illustrating a signal processing unit according to an exemplary embodiment;

FIG. 6 is a circuit diagram schematically illustrating a current-voltage converting part according to an exemplary embodiment;

FIG. 7 is a circuit diagram schematically illustrating a converting unit according to an exemplary embodiment;

FIG. 8 is a block diagram schematically illustrating a calculation unit according to an exemplary embodiment;

FIG. 9 is a block diagram schematically illustrating a power unit according to an exemplary embodiment;

FIGS. 10 through 13 are block diagrams schematically illustrating plasma monitoring tools according to an exemplary embodiment;

FIGS. 14 and 15 are diagrams schematically illustrating measurement sensors according to an exemplary embodiment;

FIGS. 16 through 18 are circuit diagrams exemplarily illustrating photoelectric conversion devices according to an exemplary embodiment;

FIGS. 19 through 21 are diagrams schematically illustrating measurement sensors according to an exemplary embodiment;

FIGS. 22 and 23 are sectional views schematically illustrating plasma monitoring tools according to an exemplary embodiment;

FIG. 24 is a block diagram illustrating a plasma chamber system according to an exemplary embodiment;

FIG. 25 is a diagram schematically illustrating a chamber apparatus according to an exemplary embodiment; and

FIG. 26 is a perspective view schematically illustrating a plasma monitoring structure, which is configured to analyze characteristics of a large-area plasma in a two-dimensional fashion, according to an exemplary embodiment.

It should be noted that these figures are intended to illustrate the general characteristics of methods, structure and/or materials utilized in certain exemplary embodiments and to supplement the written description provided below. These drawings are not, however, to scale and may not precisely reflect the precise structural or performance characteristics of any given exemplary embodiment, and should not be interpreted as defining or limiting the range of values or properties encompassed by exemplary embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Exemplary embodiments will now be described more fully with reference to the accompanying drawings, in which exemplary embodiments are shown. Exemplary embodiments may, however, be embodied in many different forms and should not be construed as being limited to the exemplary embodiments set forth herein; rather, these exemplary embodiments are provided so that this disclosure will be thorough and complete, and will fully convey the concept of exemplary embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, the element can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element's relationship or one feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Exemplary embodiments are described herein with reference to cross-sectional illustrations that are schematic illustrations of idealized exemplary embodiments (and intermediate structures) of exemplary embodiments. As such, variations from the shapes of the illustrations, as a result, for example, of manufacturing techniques and/or tolerances, are to be expected. Thus, exemplary embodiments should not be construed as limited to the particular shapes of regions illustrated herein, but should also be construed to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which the exemplary embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

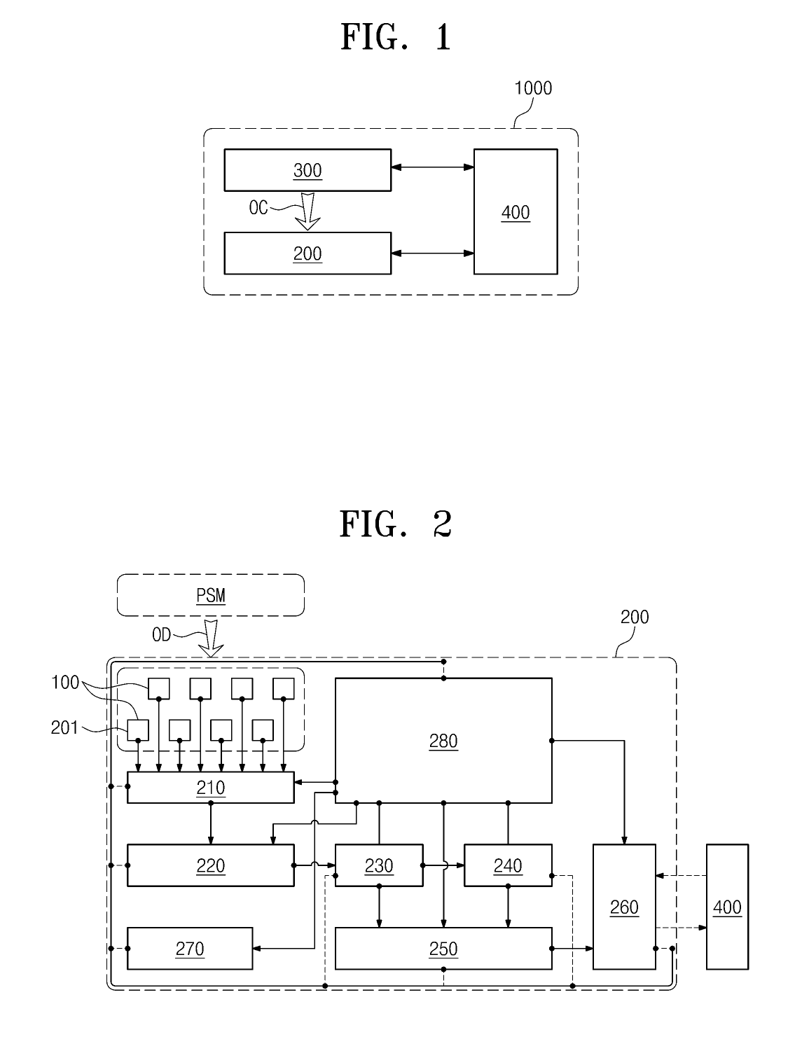

FIG. 1 is a block diagram schematically illustrating a plasma chamber system according to an exemplary embodiment.

Referring to FIG. 1, a plasma chamber system 1000 includes a chamber apparatus 300 including at least one process chamber, a plasma monitoring tool 200 configured to be loaded in the process chamber, and a system control part 400 configured to control the chamber apparatus 300.

The process chamber is configured to generate plasma, and the plasma monitoring tool 200 is configured to measure optical characteristics OC of the plasma in the process chamber. Electric or digital measurement data obtained by the plasma monitoring tool 200 may be transmitted to the system control part 400, and based on analysis of measurement data, the system control part 400 may control the chamber apparatus 300 and realize desired plasma characteristics in the at least one process chamber.

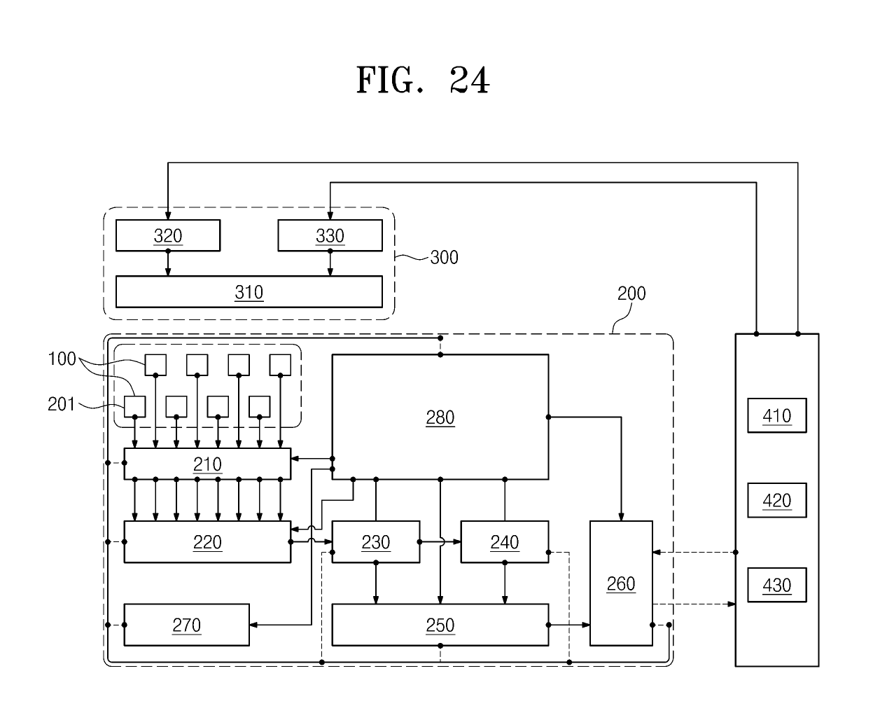

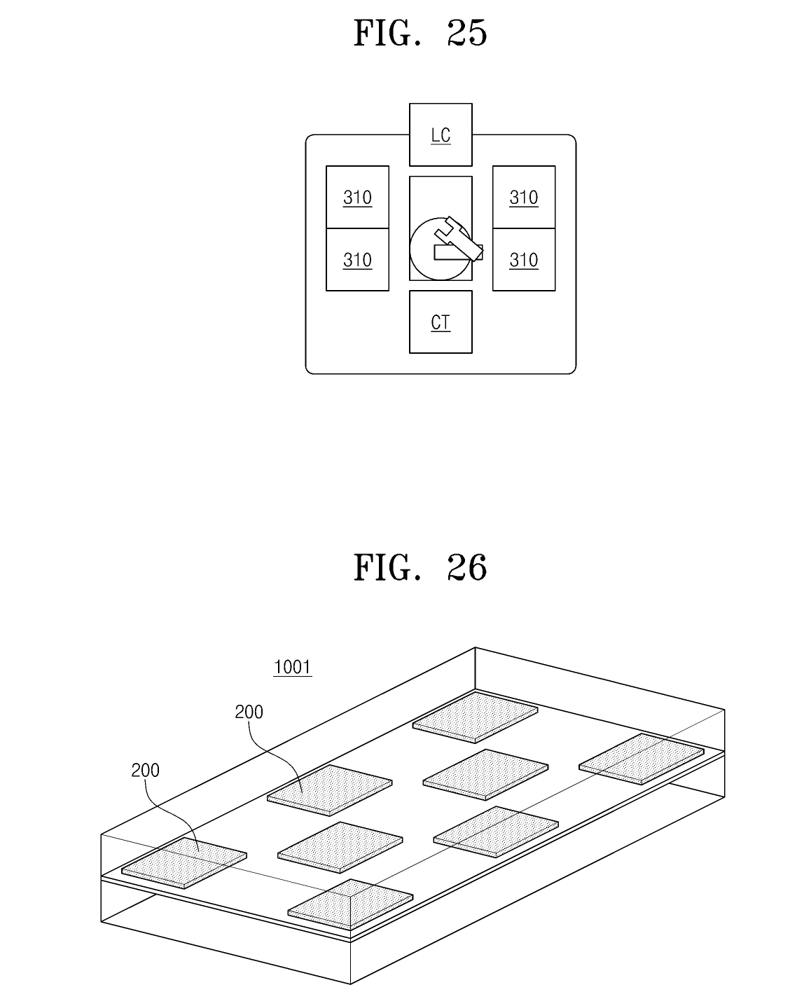

The plasma monitoring tool 200 will be described in more detail with reference to FIGS. 2 through 23, and the chamber apparatus 300 and the system control part 400 will be described in more detail with reference to FIGS. 24 and 25.

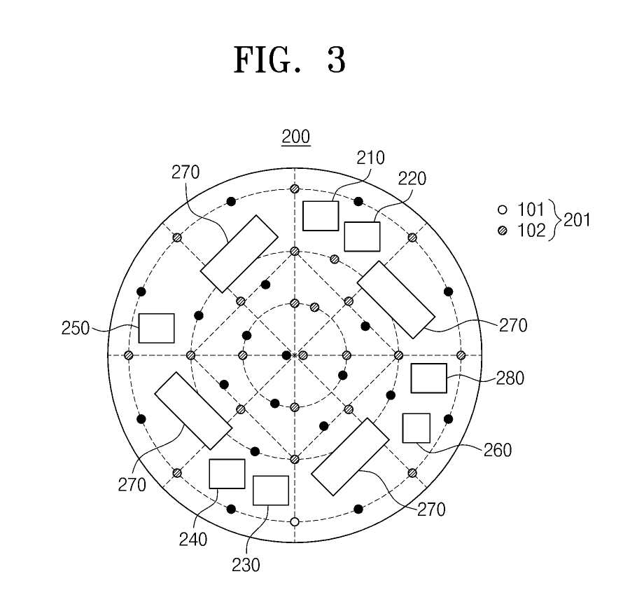

FIG. 2 is a block diagram schematically illustrating a plasma monitoring tool according to an exemplary embodiment, and FIG. 3 is a plan view exemplarily illustrating a plasma monitoring tool according to an exemplary embodiment.

Referring to FIG. 2, the plasma monitoring tool 200 includes a sensor array 201, a switching unit 210 (e.g., “switch”), a signal processing unit 220 (e.g., “signal processor”), a converting unit 230 (e.g., “converter”), a calculation unit 240 (e.g., “calculator”), a storage unit 250 (e.g. “storage”), a communication unit 260 (e.g., “communicator”), a power unit 270, and a control unit 280 (e.g., “controller”).

The sensor array 201 may include a plurality of measurement sensors 100. According to an exemplary embodiment, as shown in FIG. 3, the measurement sensors 100 may be two-dimensionally arranged in the sensor array 201. Accordingly, optical plasma characteristics OC can be two-dimensionally measured. Further, the measurement sensors 100 may be configured to convert the optical plasma characteristics OC into electrical signals (e.g., current signals). In other words, the use of the sensor array 201 makes it possible to convert the optical plasma characteristics OC to two-dimensional data of electrical signals. According to an exemplary embodiment, as exemplarily shown in FIG. 3, the sensor array 201 or the measurement sensors 100 may include at least one first measurement sensor 101 and at least one second measurement sensor 102, which are configured to measure light of different wavelengths. The sensor array 201 and the measurement sensors 100 will be described in more detail with reference to FIGS. 3 through 23.

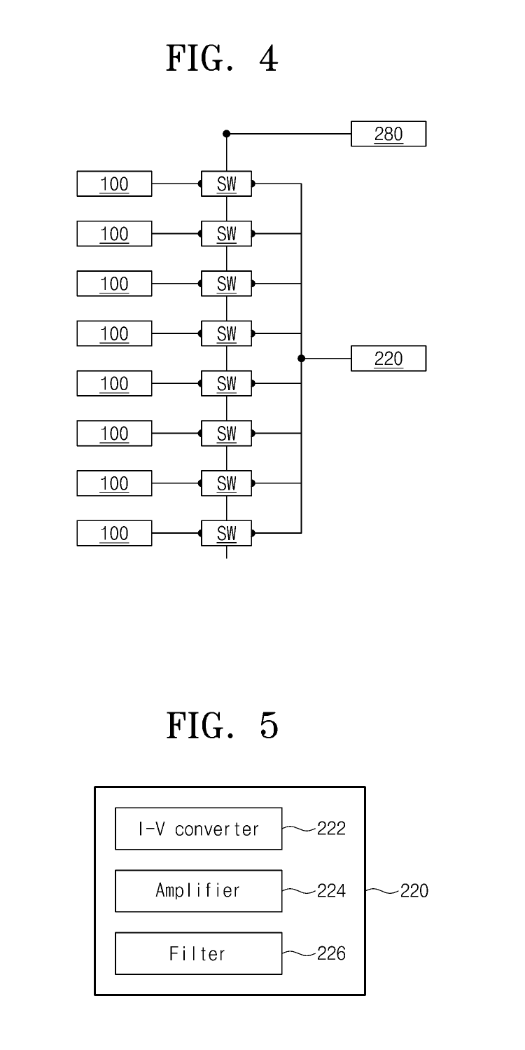

The switching unit 210 may enable the system or the user to access selectively at least one of the measurement sensors 100. For example, as shown in FIG. 4, the switching unit 21 may include input nodes connected to the measurement sensors 100, respectively, at least one output node, and switching devices SW between the input and output nodes. The switching devices SW may control the electric connection between the input and output nodes in an electric or mechanical manner, and the connection control of the switching device SW may be selectively achieved in response to control signals from the control unit 280.

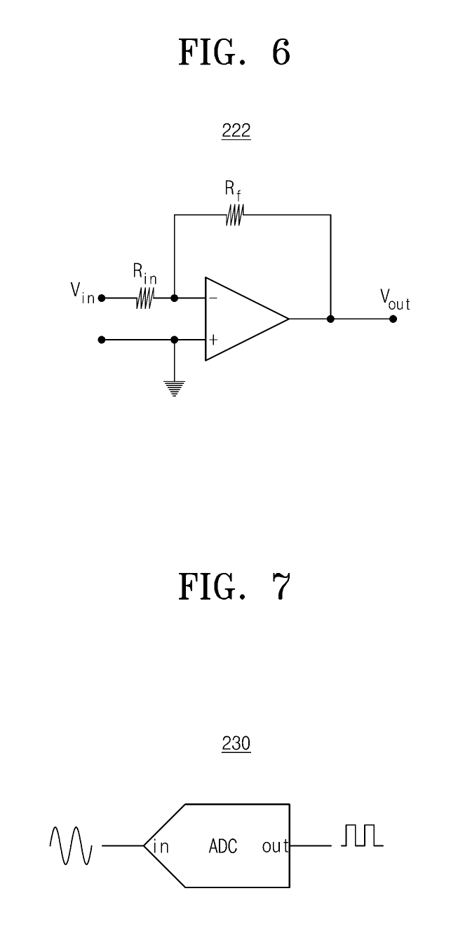

The signal processing unit 220 may include at least one of a current-voltage converting part 222 (e.g., “current-voltage converter”), a signal-amplifying part 224 (e.g., “signal amplifier”), or a signal filtering part 226 (e.g., “signal filter”), as shown in FIG. 5. The current-voltage converting part 222 may be configured to convert a current signal generated from the measurement sensors 100 to a voltage signal. According to an exemplary embodiment, the current-voltage converting part 222 may be implemented to include a circuit shown exemplarily in FIG. 6, but exemplary embodiments are not limited thereto.

The signal-amplifying part 224 may be configured to amplify an electrical signal transmitted from the measurement sensors 100 or the current-voltage converting part 222. According to an exemplary embodiment, in the case where the signal processing unit 220 includes the current-voltage converting part 222, the signal-amplifying part 224 may be configured to amplify a voltage signal converted by the current-voltage converting part 222. According to other exemplary embodiments, the signal-amplifying part 224 may be configured to amplify a current signal transmitted from the measurement sensors 100 or the switching unit 210. For example, the signal-amplifying part 224 may be provided between the measurement sensor 100 and the current-voltage converting part 222 or the signal processing unit 220 may be provided without the current-voltage converting part 222. In this case, the signal-amplifying part 224 may be configured to amplify the current signal.

The signal filtering part 226 may be configured to remove a noise from an electrical signal. According to an exemplary embodiment, the signal filtering part 226 may be provided between the measurement sensors 100 and the current-voltage converting part 222 to remove a noise from electrical signals measured by the measurement sensors 100. According to other exemplary embodiments, the signal filtering part 226 may be provided between the current-voltage converting part 222 and the signal-amplifying part 224 to remove a noise from electrical signals converted by the current-voltage converting part 222. According to still other exemplary embodiments, the signal filtering part 226 may be configured to remove a noise from electrical signals amplified by the signal-amplifying part 224.

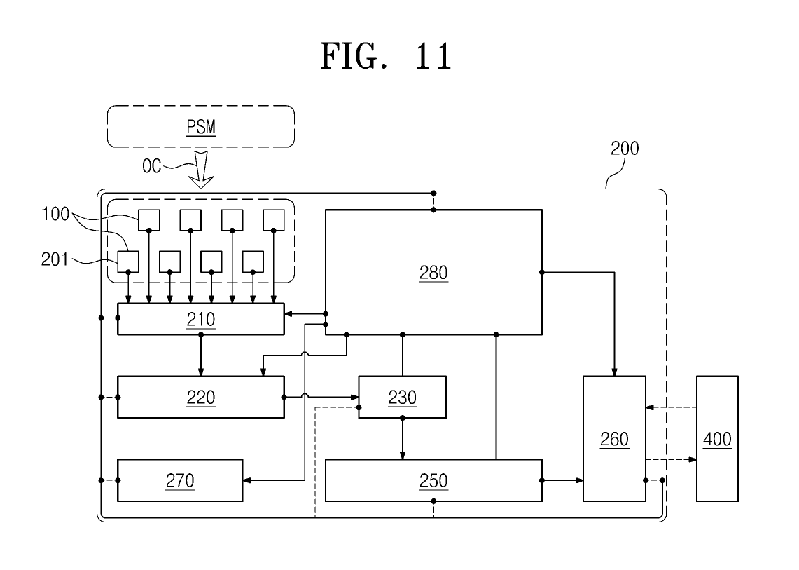

As exemplarily shown in FIG. 7, the converting unit 230 may be implemented as an analog-digital converter. In other words, the converting unit 230 may be configured to convert an analog signal input thereto into a digital signal. The signal digitized by the converting unit 230 may be stored in the storage unit 250. According to an exemplary embodiment, the storage unit 250 may be implemented as a nonvolatile memory device (e.g., FLASH memory, MRAM, PRAM, or RRAM). The use of the analog-digital converter makes it possible to reduce an amount of data to be transmitted through the communication unit 260. However, According to certain exemplary embodiments, the plasma monitoring tool 200 may be configured without at least one of the converting unit 230, the storage unit 250, or the calculation unit 240. Theses exemplary embodiments will be described with reference to FIGS. 11 through 13.

The calculation unit 240 may perform a calculation process of extracting information on plasma characteristics from data input thereto. According to an exemplary embodiment, the calculation unit 240 may be configured to perform the calculation process using an actinometry method.

For example, in the case where a plasma etching process is performed using CxFy gas, a concentration of fluorine atoms may be an important process parameter involved in the etching property. In other words, the etching property (for example, an etch rate) may be predicted by analyzing the concentration of the fluorine atoms. The concentration of the fluorine atoms may be estimated by analyzing spatially light to be emitted in a transition process (for example, [3p2P0→3s2P], 14.8 eV, 703.7 nm) of excited fluorine atoms F* in plasma. Furthermore, when argon is used for base gas, an intensity comparison between a light of 703.7 nm and an argon line of 750 nm or actinometry makes it possible to monitor temperature and density of plasma. Of course, it is understood that a method of obtaining the plasma characteristics is not limited to the above-described examples.

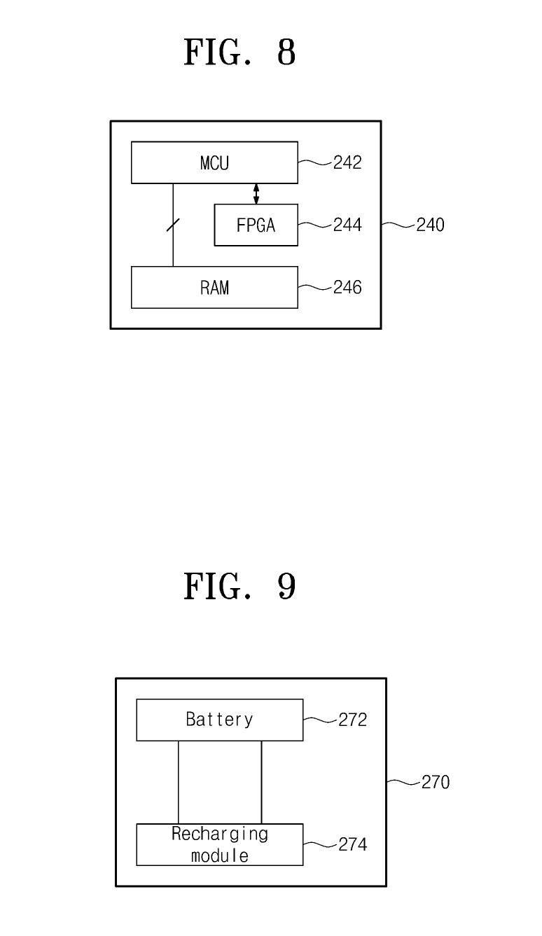

According to an exemplary embodiment, as shown in FIG. 8, the calculation unit 240 may include a micro controller unit (MCU) 242 and/or a field programmable gate array (FPGA) 244 configured to perform the calculation process. Furthermore, the calculation unit 240 may further include a memory device 246 (for example, RAM) temporarily storing data to be used for the calculation process. When the calculation process is finished, data stored in the memory device 246 may be stored in the storage unit 250 or transmitted to the outside through the communication unit 260.

According to an exemplary embodiment, the calculation unit 240 may perform the calculation process, based on information contained in the FPGA 244 and the storage unit 250. The calculation unit 240 may be configured in such a way that its calculation process can be modified by an external system or a user. For example, such a modification can be achieved by adjusting calculation parameters. The calculation parameter may be adjusted in real time by using the communication unit 260 or selectively by referring to a data table stored in the storage unit 250.

The communication unit 260 may include a data transfer module for transferring input data to the outside. The data transfer module may be configured to transfer the data in the form of an electromagnetic wave (e.g., radio wave or light). For example, the communication unit 260 may include an antenna, a wireless transceiver, and so forth, and be configured to communicate according to a variety of communication interface protocols, such as Bluetooth, CDMA, GSM, NADC, E-TDMA, WCDMA, CDMA2000, Wi-Fi, Muni Wi-Fi, DECT, Wireless USB, Flash-OFDM, IEEE 802.20, GPRS, iBurst, WiBro, WiMAX, WiMAX-Advanced, UMTS-TDD, HSPA, EVDO, LTE-Advanced, and MMDS. According to an exemplary embodiment, the communication unit 260 may further include a data input module configured to receive data from the outside.

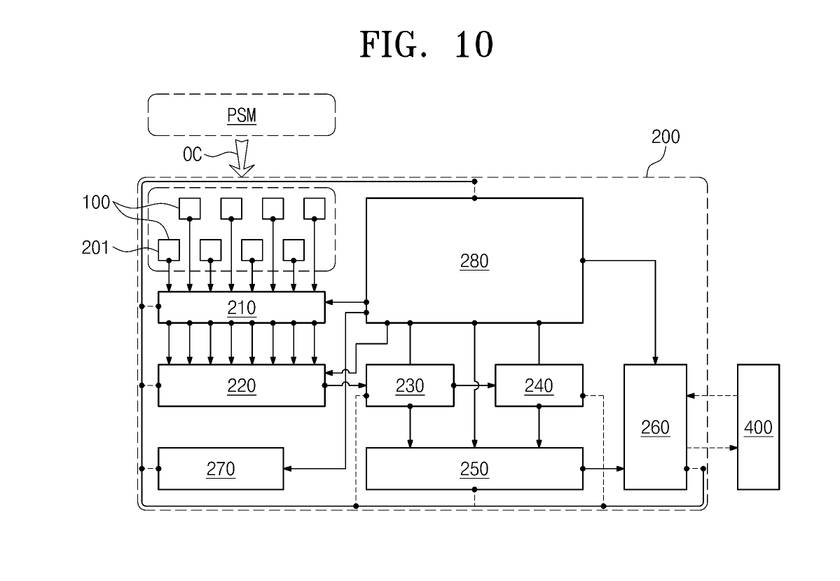

The power unit 270 may be configured to supply electric power to the sensor array 201, the switching unit 210, the signal processing unit 220, the converting unit 230, the calculation unit 240, the storage unit 250, the communication unit 260, and the control unit 280. According to an exemplary embodiment, the power unit 270 may include a rechargeable battery 272 (e.g., a secondary battery). According to an exemplary embodiment, the battery 272 may be a battery containing nickel-cadmium, lithium ion, nickel-hydrogen, or lithium polymer. Furthermore, as shown in FIG. 9, the power unit 270 may further include a re-charging module 274 for recharging the battery 272. The re-charging module 274 may be configured to charge the battery 272, in a wireless manner, using for example at least one of magnetic induction, magnetic resonance, or electromagnetic wave techniques.

The control unit 280 may be configured to control operations of the sensor array 201, the switching unit 210, the signal processing unit 220, the converting unit 230, the calculation unit 240, the storage unit 250, the communication unit 260, the power unit 270, and the control unit 280.

FIGS. 10 through 13 are block diagrams schematically illustrating plasma monitoring tools according to other exemplary embodiments. Except for the differences to be described below, the plasma monitoring tools of FIGS. 10 through 13 may be configured to have substantially the same features as those in the previous exemplary embodiments of FIGS. 2 through 9. Thus, for convenience of description, a description of the aforesaid technical features may be omitted below. Furthermore, technical modifications to be described with reference to each of FIGS. 10 through 13 may be applied to realize other exemplary embodiments of FIGS. 10 through 13.

As shown in FIG. 10, electrical signals measured by the sensor array 201 may be transmitted to the switching unit 210 via the signal processing unit 220. In other words, the signal processing unit 220 may be provided between the sensor array 201 and the switching unit 210. Referring back to FIG. 5, according to an exemplary embodiment, each of the current-voltage converting part 222, the signal-amplifying part 224, and the signal filtering part 226 may be provided between the sensor array 201 and the switching unit 210. According to other exemplary embodiments, at least one of the current-voltage converting part 222, the signal-amplifying part 224, or the signal filtering part 226 may be disposed between the sensor array 201 and the switching unit 210.

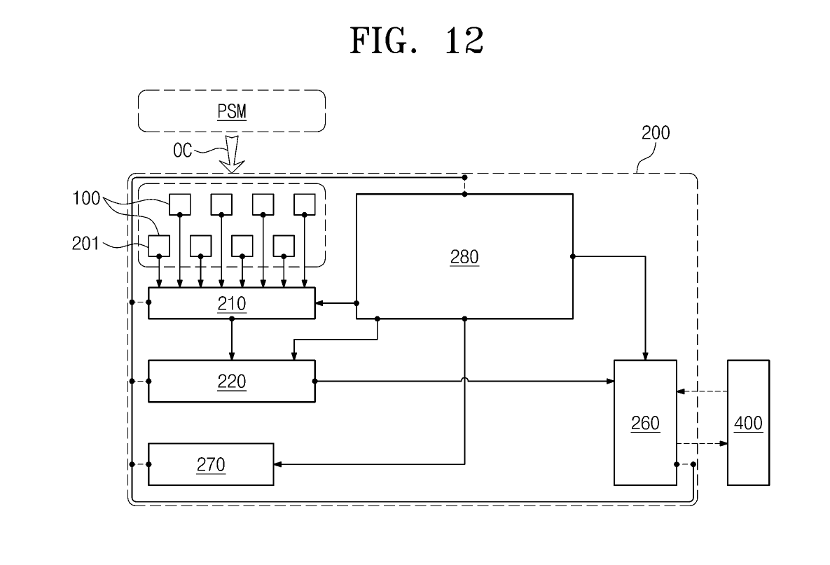

The plasma monitoring tool may be configured not to have at least one of the calculation unit 240 or the storage unit 250. For example, the plasma monitoring tool may be provided without the calculation unit 240, as shown in FIG. 11, and without any of the converting unit 230, the calculation unit 240, and the storage unit 250, as shown in FIG. 12. In this case, the calculation process may be performed in an external system, and to perform this external calculation, electrical signals output from the signal processing unit 220 may be transmitted to the external system through the communication unit 260.

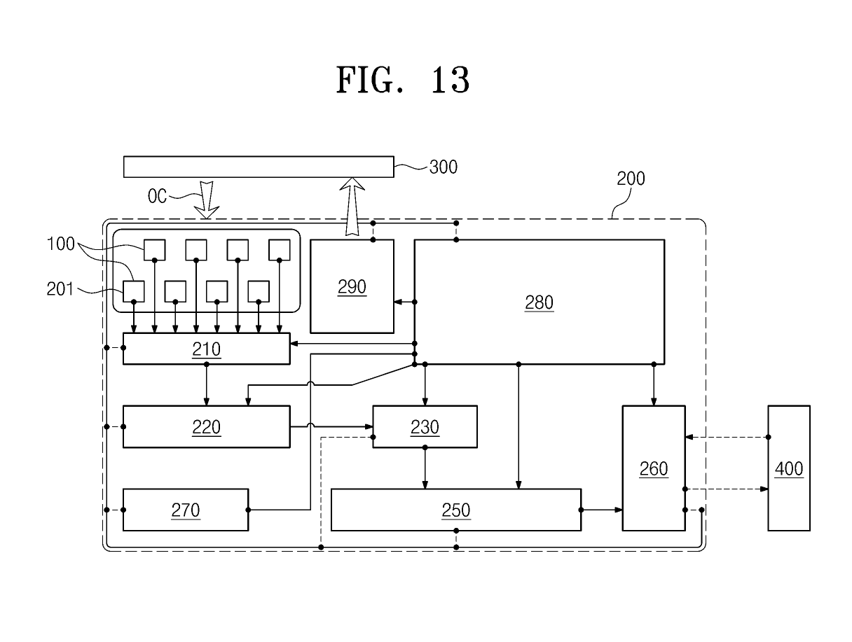

According to an exemplary embodiment, the plasma monitoring tool may further include a light-emitting unit 290 (e.g., “light emitter”), as shown in FIG. 13. The light-emitting unit 290 may be configured to emit light toward the chamber apparatus 300 (e.g., a showerhead), in response to control signals from the control unit 280. The light-emitting of the light-emitting unit 290 may be realized using electric power to be supplied from the power unit 270. The emitted light may be reflected by the chamber apparatus 300 (e.g., the showerhead) and be incident on the sensor array 201. In this case, optical data measured by the sensor array 201 may be used to analyze a degree of pollution of the chamber apparatus 300. The pollution analyzing process may be performed when plasma is not generated in the chamber apparatus 300.

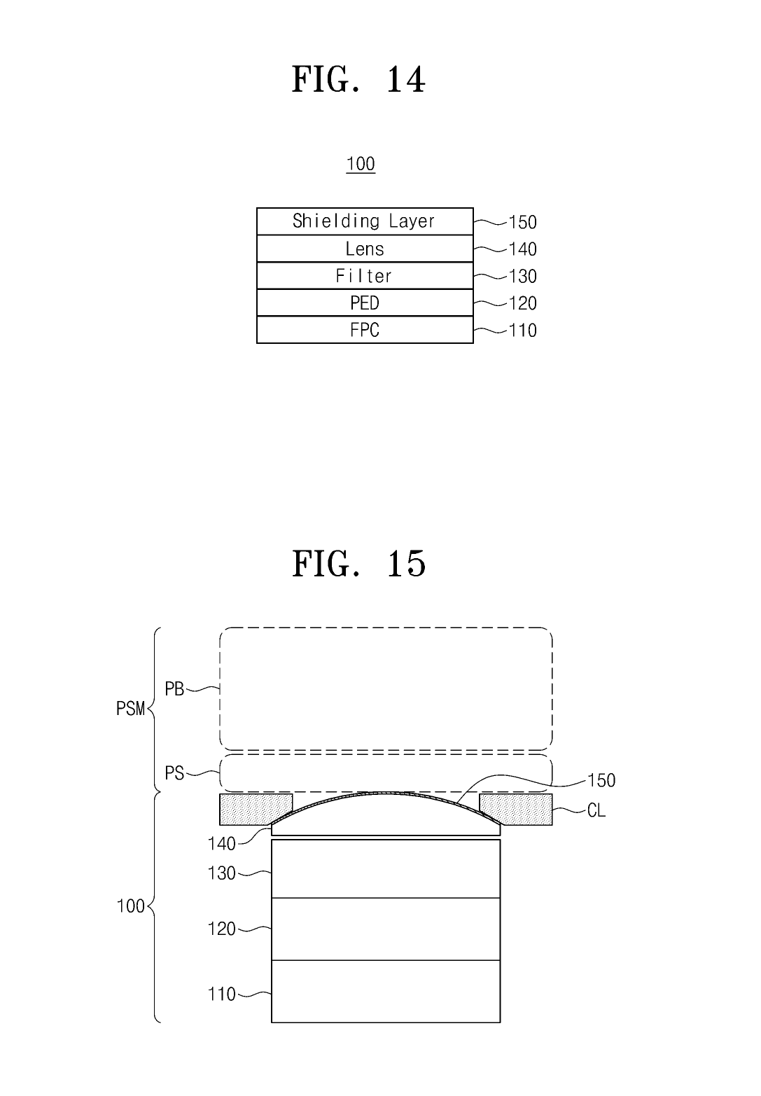

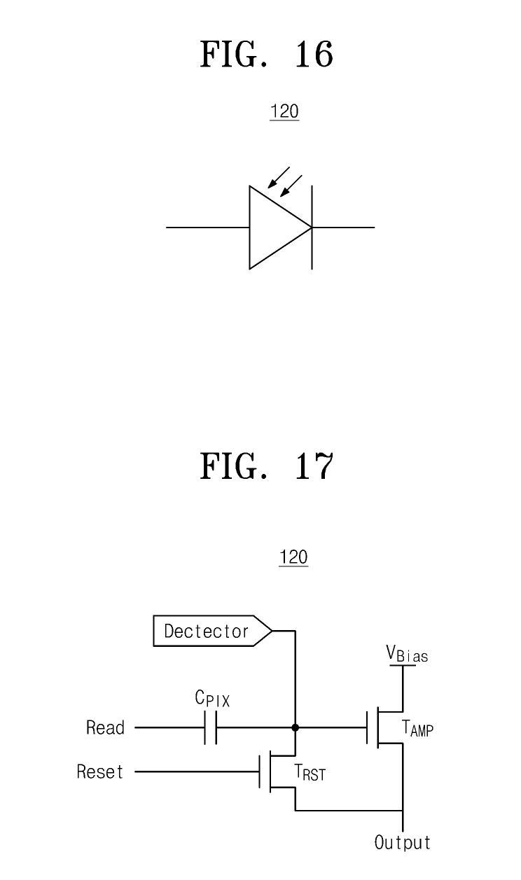

FIGS. 14 and 15 are diagrams schematically illustrating measurement sensors according to an exemplary embodiment. FIGS. 16 through 18 are circuit diagrams exemplarily illustrating photoelectric conversion devices according to an exemplary embodiment. FIGS. 19 through 21 are diagrams schematically illustrating measurement sensors according to other exemplary embodiments.

Referring to FIGS. 14 and 15, each of the measurement sensors 100 may include a photoelectric conversion device 120, an optical filter 130, a light-guide structure 140, and an upper shielding layer 150 sequentially provided on a substrate 110.

The substrate 110 may be a flexible printed circuit board. According to an exemplary embodiment, the substrate 110 may include an interconnection structure connecting the photoelectric conversion device 120 to an external electronic device. Here, the external electronic device may be one of the switching unit 210, the signal processing unit 220, the converting unit 230, the calculation unit 240, the storage unit 250, the communication unit 260, the power unit 270, and the control unit 280.

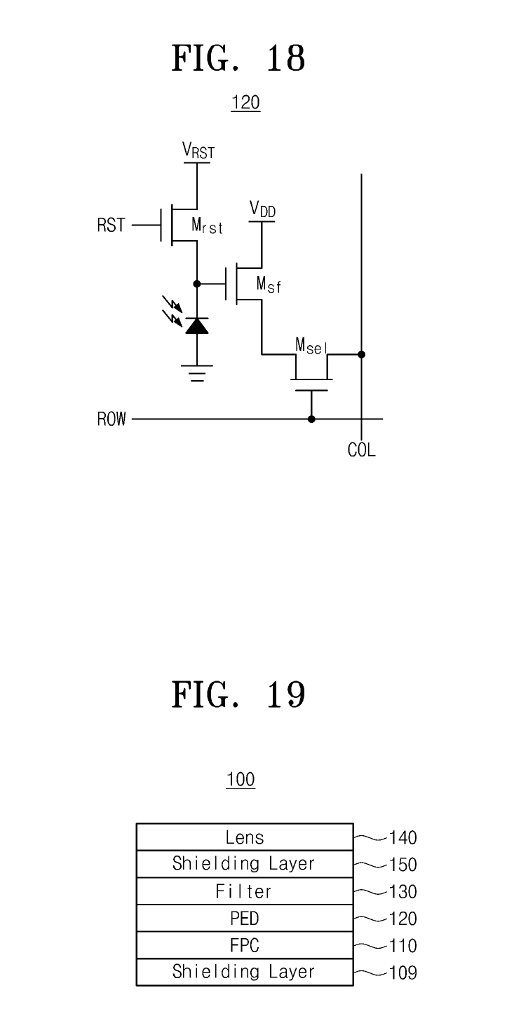

The photoelectric conversion device 120 may be configured to convert light to electrical signals using, for example, a photoelectric conversion effect. The light to be incident into the photoelectric conversion device 120 may originate from plasma PSM (e.g., a plasma bulk region PB and a plasma sheath region PS). According to an exemplary embodiment, the photoelectric conversion device 120 may be provided in the form of a photodiode, as shown in FIG. 16. According to other exemplary embodiments, as exemplarily shown in FIGS. 17 and 18, the photoelectric conversion device 120 may be provided in the form of an image sensor including a photodiode and two or three transistors. Of course, it is understood that exemplary embodiments are not limited to a specific type of the photoelectric conversion device 120.

By using the optical filter 130, it is possible to provide light with a desired wavelength selectively into the photoelectric conversion device 120. According to an exemplary embodiment, the optical filter 130 may be configured to enable incident light of 703.7 nm and/or 750 nm to be selectively transmitted therethrough. As described with reference to FIG. 3, the measurement sensors 100 may include at least one first measurement sensor 101 and at least one second measurement sensor 102 configured to measure lights (e.g., first light and second light) having different wavelengths. The first measurement sensors 101 may differ from the second measurement sensors 102, in terms of a structure of the optical filter 130 provided therein.

According to an exemplary embodiment, the light-guide structure 140 may include an optically-transparent lens (e.g., a convex lens, as shown in FIG. 15). The upper shielding layer 150 may contain a conductive material. For example, in the case where, as shown in FIG. 15, the light-guide structure 140 is a transparent lens, the upper shielding layer 150 may include a transparent conductive layer (for example, ITO or IZO layer) coated on a top and/or bottom surface of the lens. Due to the presence of the upper shielding layer 150, it is possible to prevent charged particles to be incident into the photoelectric conversion device 110 from the plasma PSM and to prevent the photoelectric conversion device 110 from being electrically affected by the charged particles. According to an exemplary embodiment, the plasma monitoring tool 200 may be loaded in the chamber apparatus 300 and thereby be in direct contact with plasma, and thus, in the absence of the upper shielding layer 150, there may be a malfunction of the plasma monitoring tool. In other words, the presence of the upper shielding layer 150 makes it possible to improve measurement reliability of the plasma monitoring tool.

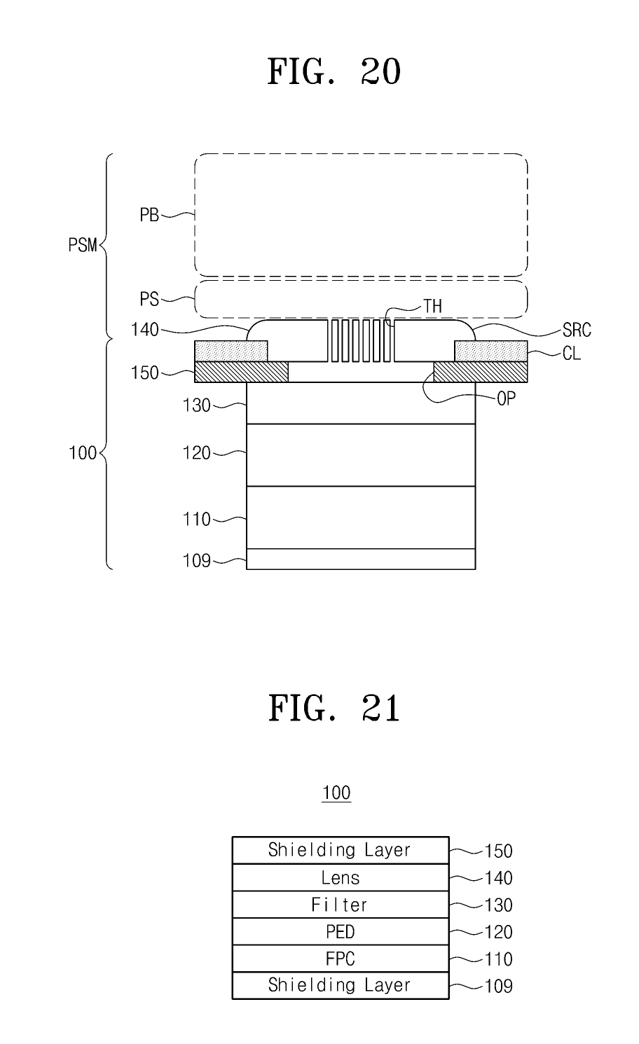

According to other exemplary embodiments, the light-guide structure 140 may include a sensor cover SRC, in which at least one through hole TH is formed, as shown in FIG. 20. The through hole TH may be formed to penetrate the sensor cover SRC, and thereby enable the incident light to be propagated to the optical filter 130 or the photoelectric conversion device 120. The sensor cover SRC may be formed of a material capable of preventing plasma from exhibiting characteristics different from that in an actual process. For example, the sensor cover SRC may be formed of silicon, silicon oxide, or ceramics. According to an exemplary embodiment, the sensor cover SRC may be configured to have an optically-opaque property. For example, the sensor cover may be formed of or include an optically-opaque material, for light having a range of wavelengths which are capable of being transmitted through the optical filter 130.

In the case where the light-guide structure 140 is provided in the form of the sensor cover SRC, the upper shielding layer 150 may include a metal layer disposed below the sensor cover SRC. As shown in FIG. 20, the upper shielding layer 150 or the metal layer may have an opening OP formed below the through hole TH. According to other exemplary embodiments, the upper shielding layer 150 with the opening OP may be provided on the sensor cover SRC, as shown in FIGS. 14 and 21.

According to still other exemplary embodiments, the measurement sensors 100 may further include a lower shielding layer 109 disposed below the substrate 110, as shown in FIGS. 19 and 21. The lower shielding layer 109 may be configured to include a conductive material (for example, a metal layer). Due to the presence of the lower shielding layer 109, it is possible to prevent the photoelectric conversion device 110 from electrically interacting with any element located thereunder. In other words, the lower shielding layer 109 may help to improve further the measurement reliability of the plasma monitoring tool.

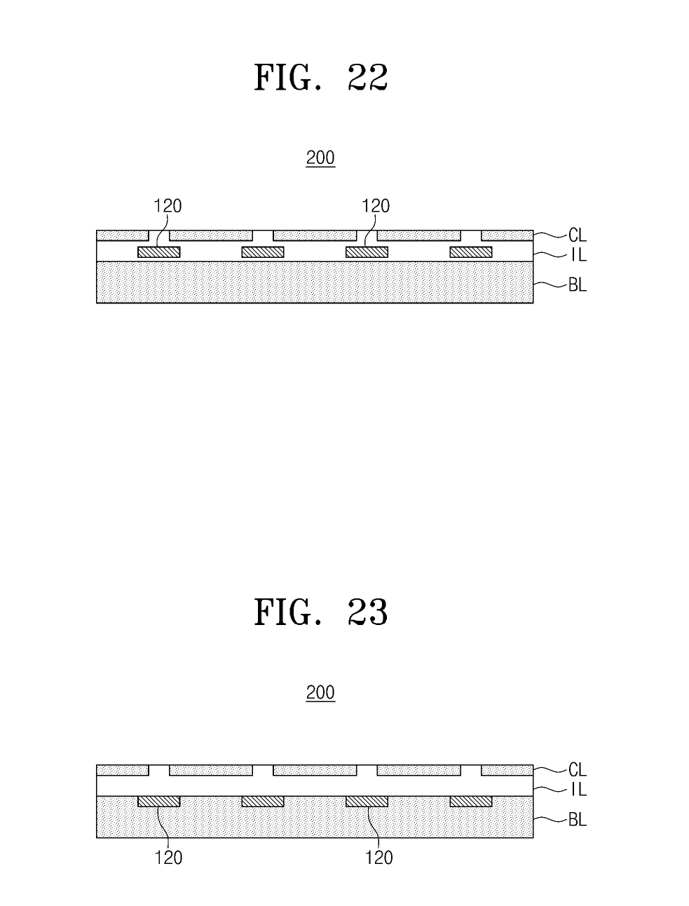

FIGS. 22 and 23 are sectional views schematically illustrating plasma monitoring tools according to an exemplary embodiment.

Referring to FIGS. 22 and 23, when viewed in a sectional view, the plasma monitoring tool 200 may include a cover layer or lower housing CL, a body layer or upper housing BL, and an intermediate layer IL interposed therebetween. The sum of thicknesses of the cover, body, and intermediate layers CL, BL, and IL may range from about 500 micrometer to 0.5 centimeters. Accordingly, the plasma monitoring tool 200 can be loaded into the chamber apparatus 300, as described above.

According to an exemplary embodiment, the cover layer CL and the body layer BL or at least outer layers thereof may be formed of materials capable of preventing a state of plasma from being changed thereby, or may be formed of materials used in an actual measurement process. For example, the outer surfaces of the cover layer CL and the body layer BL may be formed of silicon, silicon oxide, silicon nitride, or ceramics.

According to an exemplary embodiment, the body layer BL may be a semiconductor wafer or a wafer-shaped structure, which may be prepared by processing a wafer. According to other exemplary embodiments, the body layer BL may be a plate-shaped structure, in which a semiconductor layer is included. In the case where the body layer BL is the semiconductor wafer or includes the semiconductor layer, the photoelectric conversion devices 120 of the measurement sensors 100 may be integrated on the body layer BL. In other words, as shown in FIG. 23, the substrate 110 and the photoelectric conversion devices 120 may be provided as a part of the body layer BL.

According to other exemplary embodiments, the substrate 110 may be provided in the form of a flexible printed circuit board, and the photoelectric conversion devices 120 may be separately fabricated and then mounted on the substrate 110. For example, as shown in FIG. 22, the photoelectric conversion devices 120 may be implemented as a structure provided in the intermediate layer IL.

When viewed in a sectional view, the switching unit 210, the signal processing unit 220, the converting unit 230, the calculation unit 240, the storage unit 250, the communication unit 260, the power unit 270, and the control unit 280 may constitute the intermediate layer IL. According to an exemplary embodiment, the substrate 110, the photoelectric conversion device 120, the optical filter 130, the light-guide structure 140, the lower shielding layer 109, and the upper shielding layer 150 may constitute the intermediate layer IL. According to other exemplary embodiments, as described above, the substrate 110 and the photoelectric conversion device 120 may constitute the body layer BL, while the optical filter 130, the light-guide structure 140, the lower shielding layer 109, and upper shielding layer 150 may constitute the intermediate layer IL.

The cover layer CL may be formed to have openings. The openings may be formed at positions corresponding to positions of the photoelectric conversion devices 120. According to an exemplary embodiment, the photoelectric conversion devices 120 may be inserted into the openings, respectively. According to other exemplary embodiments, the light-guide structure 140 may be not provided, and the cover layer CL may serve as the light-guide structure 140. According to still other exemplary embodiments, apart from the presence of the cover layer CL, the light-guide structure 140 may be provided, as shown in FIG. 20. For example, as shown in FIG. 20, the light-guide structure 140 may be implemented as the sensor cover SRC inserted into the cover layer CL. The sensor cover SRC may have a larger thickness than a thickness of the cover layer CL. In this case, it is possible to increase a length of the through hole TH, thereby enabling the photoelectric conversion device 120 to observe the plasma PSM with an increased spatial resolution.

FIG. 24 is a block diagram illustrating a plasma chamber system according to an exemplary embodiment.

Referring to FIG. 24, the system control part 400 includes a system control communication unit 410, a system control calculation unit 420, and a system control storage 430. The system control communication unit 410 may be configured to read out measurement data from the plasma monitoring tool 200, the system control calculation unit 420 may be configured to calculate plasma property data from the measurement data, and the system control storage 430 may be configured to store an algorithm to perform the reading and calculation operations, and to store the measurement data and the plasma property data.

The chamber apparatus 300 may include a process chamber 310, a gas-supplying part 320 (e.g., “gas supplier”), and a high frequency generation part 330 (e.g., “high frequency generator”). The system control part 400 may control at least one of the process chamber 310, the gas-supplying part 320, and the high frequency generation part 330, based on the plasma property data. For example, the plasma property data may be used to control a process property of the chamber apparatus 300. According to an exemplary embodiment, the system control communication unit 410 may be provided in the process chamber 310 to read out the measurement data in real time.

According to an exemplary embodiment, as shown in FIG. 25, the chamber apparatus 300 may include at least one process chamber 310, at least one load-lock chamber LC, and a container CT, in which the plasma monitoring tool 200 is contained. The load-lock chamber LC may enable the at least one process chamber 310 and the container CT to be maintained in substantially a vacuum state. Further, since the container CT is provided in the chamber apparatus 300, it is possible to reduce the number of interruptions of the vacuum state, which may occur when the container CT is unloaded from the chamber apparatus 300. The container CT may include a charging module which enables the power unit (e.g., battery) 270 equipped in the plasma monitoring tool 200 to be recharged in a wireless manner. Further, at least a part of the system control communication unit 410 of the system control part 400 may be provided in the container CT.

In the case of fabricating display devices, it may be necessary to produce large-area plasma. In this case, as shown in FIG. 26, a plasma monitoring structure 1001 including a plurality of monitoring tools 200 may be used to analyze properties of the large-area plasma two-dimensionally. According to exemplary embodiments, each or at least one of the monitoring tools 200 included in the plasma monitoring structure 1001 may be configured to have substantially the same features as at least one of the above-described plasma monitoring tools 200 according to exemplary embodiments.

According to exemplary embodiments, provided is a plasma monitoring tool which can be loaded in a chamber to two-dimensionally measure characteristics of plasma.

While certain exemplary embodiments have been particularly shown and described, it will be understood by one of ordinary skill in the art that variations in form and detail may be made therein without departing from the spirit and scope of the exemplary embodiments, as defined in the following claims.

What is claimed is:

1. A plasma monitoring tool, comprising:
a housing; and
a sensor array, a signal processor, and a data-transferring device, each of the sensor array, the signal processor, and the data-transferring device being provided in the housing,
wherein the sensor array comprises a plurality of measurement sensors two-dimensionally arranged in the housing, each of the measurement sensors comprising a shielding layer configured to prevent an electrical interaction with charged particles in plasma,
the signal processor is configured to process electrical signals produced by the measurement sensors, and thereby generate measurement data, and
the data-transferring device is configured to transmit the measurement data to the outside.

2. The plasma monitoring tool of claim 1, wherein each of the measurement sensors further comprises a light-guide structure comprising an optically-transparent lens or a cover with at least one through hole.

3. The plasma monitoring tool of claim 2, wherein the shielding layer comprises a transparent conductive layer or a metal layer provided on the light-guide structure or at a side of the light-guide structure opposite to a side at which the plasma is located.

4. The plasma monitoring tool of claim 1, further comprising a flexible printed circuit board provided in the housing and provided with a wiring structure,
wherein the sensor array, the signal processor, and the data-transferring device are mounted on the flexible printed circuit board and are electrically connected to each other via the wiring structure.

5. The plasma monitoring tool of claim 4, wherein each of the measurement sensors comprises a photoelectric conversion device mounted on the flexible printed circuit board.

6. The plasma monitoring tool of claim 1, wherein the housing comprises:
a plate-shaped lower housing; and
an upper housing comprising an opening formed at a position corresponding to a position of one of the measurement sensors,
wherein the upper housing comprises silicon, silicon oxide, or ceramics.

7. The plasma monitoring tool of claim 6, wherein the plate-shaped lower housing comprises a semiconductor wafer or a plate-shaped structure comprising a semiconductor layer, and
each of the measurement sensors comprises a photoelectric conversion device integrated on a top surface of the plate-shaped lower housing.

8. The plasma monitoring tool of claim 1, further comprising:
a data storage provided in the housing to store the measurement data; and
a power-supplying device provided in the housing to supply electric power to electronic components in the housing.

9. The plasma monitoring tool of claim 1, wherein the data-transferring device comprises a data transfer module configured to wirelessly transmit the measurement data, in the form of an electromagnetic wave, to the outside.

10. The plasma monitoring tool of claim 1, wherein the signal processor comprises:
a current-voltage converter configured to convert current signals generated in the measurement sensors into voltage signals,
a signal-amplifier configured to amplify electrical signals transmitted from the measurement sensors or the voltage signals transmitted from the current-voltage converter,
a signal filter configured to remove noises from the amplified signals and thereby generate filtered signals, and
an analog-digital converter configured to convert the filtered signals to a digital signal.

11. The plasma monitoring tool of claim 10, further comprising a calculator provided in the housing to obtain plasma property data from the electrical signals or the digital signal.

12. The plasma monitoring tool of claim 1, further comprising a switch provided in the housing, the switch being configured to selectively provide access to one of the measurement sensors.

13. The plasma monitoring tool of claim 1, wherein the measurement sensors comprise at least one first measurement sensor and at least one second measurement sensor, and the first and second measurement sensors are configured to respectively measure first light and second light having wavelengths which are different from each other.

14. The plasma monitoring tool of claim 1, further comprising a light emitter disposed in the housing,
wherein the emitter is configured to emit light having a wavelength which is in a range that can be detected by the measurement sensors.
